(19) United States
(12) Patent Application Publication
(10) Pub. No.: US 2024/0247928 A1
(43) Pub. Date: Jul. 25, 2024

(54) SYSTEM AND METHOD FOR ESTIMATING THE DEPTH OF AT LEAST ONE POTHOLE THAT IS AT LEAST PARTIALLY FILLED WITH WATER, AND CORRESPONDING DRIVER ASSISTANCE SYSTEM

(71) Applicant: ZF Friedrichshafen AG, Friedrichshafen (DE)

(72) Inventors: Neeraj Tiwari, Friedrichshafen (DE); Sindhu Venna, Friedrichshafen (DE)

(73) Assignee: ZF Friedrichshafen AG, Friedrichshafen (DE)

(21) Appl. No.: 18/577,544

(22) PCT Filed: Jun. 13, 2022
(86) PCT No.: PCT/EP2022/065937

§ 371 Date: Jan. 8, 2024

(30) Foreign Application Priority Data
Jul. 8, 2021 (DE) 10 2021 207 204.6

(51) Int. Cl. G01B 11/22; B60W 30/09; B60W 40/06; B60W 50/14; B60W 60/00; G06V 10/70; G06V 20/56; H04N 23/23

(52) U.S. Cl. CPC G01B 11/22; B60W 30/09; B60W 40/06; B60W 50/14; B60W 60/0015; G06V 10/70; G06V 20/588; H04N 23/23; B60W 2420/403; B60W 2420/408; B60W 2552/35

(57) ABSTRACT

A system for estimating the depth of an at least partially water-filled pothole by a driver assistance system includes an optical camera sensor configured to detect the pothole based on camera data, a thermal camera sensor configured to determine a road surface temperature including the surface of the pothole based on temperature determination of pixels in a thermal pixel image, a processor configured to determine the surface temperature of the pothole detected by the optical camera sensor, based on the road surface temperature detected by the thermal camera sensor, and estimate the depth of the pothole based on its surface temperature.

The present application relates to a system for estimating the depth of at least one at least partially water-filled pothole by a driver assistance system provided in a vehicle. Further the application relates to a method for estimating the depth of at least one at least partially water-filled pothole and a driver assistance system implementing such a method.

In general, potholes are caused by pavement coming under severe stress from severe weather and the constant pressure of oncoming traffic. Potholes are caused by the expansion and contraction of water hat seeps into the ground under the asphalt and pavement.

Road Cracks/Holes are the major cause of accidents, all over the world.

A recent study from AAA (American Automobile Association), published on the internet, shows that over the past five years around 16 million drivers across the U.S. have suffered damage from potholes. The study from AAA reveals that pothole damage has cost U.S. drivers $15 billion in vehicle repairs over the last five years, or approximately $3 billion annually.

That cost comes in the form of more vehicle repairs, higher maintenance and other operating expenses.

There are several methods and systems for detecting potholes. U.S. Pat. No. 9,626,763 B1 discloses a system for detecting potholes, comprising: an input interface configured to: receive sensor data of a vehicle; a vehicle event recorder processor configured to: determine a pothole based at least in part on the sensor data; store pothole data associated with the pothole, wherein the pothole data comprises a pothole video; and provide the pothole data, wherein a pothole rating of the pothole is determined and stored based at least in part on the pothole data, wherein the pothole rating comprises a driving avoidability rating, a visibility rating, or any combination thereof.

U.S. Pat. No. 4,653,316 A discloses a road surface condition detecting apparatus mounted on a vehicle, said apparatus comprising; laser beam scanning means for scanning by a laser beam a road surface in a transverse direction; image pick-up means for picking up locus of a scanning of said laser beam in an inclined direction for producing transverse profile data of the road surface; light receiving means for receiving a laser beam reflected from said road surface in an inclined direction for producing crack data of said road surface; road distance detecting means for measuring distances to said road surface from three positions on a line in the longitudinal direction of said vehicle for producing longitudinal profile data of said road surface; running distance detecting means for measuring a running distance of said vehicle; and recording means for recording data respectively produced by said image pick-up means, said light receiving means and said distance detecting means together with the running distance data produced by said running distance detecting means.

It is an object of the present invention to provide an improved system and a method for automatically detecting potholes. A further object is to provide an improved driver assistance system.

This object is achieved by a system with the features of claim 1 and a driver assistance system with the features of claim 8 and a method with the features of claim 13.

The dependent claims list further advantageous measures which can be combined with one another, as desired, in order to achieve further advantages.

The object is achieved by a system for estimating the depth of at least one at least partially water-filled pothole by a driver assistance system provided in a vehicle, the system comprising:
at least one optical camera sensor configured to detect the at least one at least partially water-filled pothole based on camera data generated by the optical camera sensor,
at least one thermal camera sensor configured to determine a road surface temperature, whereby the road surface comprises the surface of the at least one at least partially water-filled pothole, whereby the determination of the road surface temperature is based on the temperature determination of the pixels in a thermal pixel image generated by the at least one thermal camera sensor,
a processor configured to determine the surface temperature of the at least one at least partially water-filled pothole, detected by the at least one optical camera sensor, based on the road surface temperature detected by the at least one thermal camera sensor, and further configured to estimate the depth of the at least one at least partially water-filled pothole based on its surface temperature.

A pothole can also be a road crack. A water-filled pothole can also comprise water and another fluid.

Preferably the water-filled pothole is completely filled with water.

It was noticed, that open road cracks/potholes are visible from a considerable distance, and therefore can be detected by systems/methods as mentioned in the prior art. However, it was further noticed, that these methods are not reliable in all environmental conditions, especially not when these potholes are filled with water because of rain, snow or by other cause. Furthermore, until now, it is very difficult to get the depth information of these potholes. So, if the vehicle encounters such a (deep) water-filled pothole, a major accident or discomfort in riding can occur. Furthermore, the vehicle can be extremely damaged, especially by deep potholes, which leads to higher maintenance and other operating expenses.

The invention is based on the further recognition that the surface temperature for deep water-filled potholes will be less in comparison to narrow water-filled potholes.

The invention enables therefore the determination of the depth of at least one at least partially water-filled pothole by the fusion of a thermal camera sensor and an optical camera sensor, so that a pothole with a large depth can be avoided. This enables the driver to have a safe and smooth ride. Furthermore, damages otherwise caused by deep potholes can be avoided.

The invention enables the estimation of a pothole's depth through detection of accumulated temperature, by means of combining sensor signals obtained from the optical camera sensor and the thermal camera sensor. In general, such cameras are already installed in a vehicle. By having the temperature determination for each pixel in the thermal pixel image, it is possible to determine the depth of the water-filled potholes in any environment, even like fog, rain or at night. Especially in fog, when the front scene is usually not even visible or in other extreme weather conditions, a depth estimation for water-filled potholes can be given.

In a preferred embodiment the thermal camera is a high-speed infrared imaging camera, allowing the generation of a high-speed thermal imaging with a good resolution at a rapid frame rate.

In one embodiment, the optical camera sensor generates a picture of the road scene and then segments the areas of the potholes from the rest (remainder) of the scene. Therefore, the camera consists or uses preferably a Convolution Neural Network (CNN) for fast and accurate real time segmentation. Alternative other image processing algorithms like other artificial neural networks or pattern recognition can be used.

In one embodiment the at least one optical camera sensor and the at least one thermal camera sensor are arranged on a windshield of the vehicle. In another further embodiment the at least one optical camera sensor and the at least one thermal camera sensor are arranged on the top of the windshield. Thereby a large field of view can be achieved. As a result, road images can be generated having a great distance to the vehicle. This allows deep potholes to be detected at a great distance.

In a further aspect of the present invention the at least one optical camera sensor is a RGB (Red, Green, Blue) camera sensor. This is a common inexpensive camera usually equipped with a standard CMOS sensor through which the colour images are acquired. The resolution of static images is usually given in megapixels.

In another embodiment the processor is configured to determine the surface temperature of the at least one at least partially water-filled pothole from a measured emission spectrum by using Planck's law of black body radiation. To determine the surface temperature, the black body emission concept (Planck's law) may be used, so that a precisely accumulated temperature determination of a pothole's surface is possible. The integration of Planck's law over all frequencies provides the total energy per unit of time per unit of surface area radiated by a black body maintained at a temperature T. This is known as the Stefan-Boltzmann law.

The Stefan-Boltzmann law describes the power radiated from a black body in terms of its temperature. More specifically, the Stefan-Boltzmann law states that the total energy radiated per surface area A of a black body across all wavelengths per unit time (also known as the black-body radiant emittance) is directly proportional to the fourth power P of the black body's thermodynamic temperature T:

$$\frac{P}{A} = σ {T}^{4}$$

where σ is the Stefan-Boltzmann constant.

To remain in thermal equilibrium at constant temperature T for example, the black body must absorb or internally generate this amount of power P over the given surface area A.

In one embodiment the processor is configured to estimate the depth of the at least one at least partially water-filled pothole using a trained machine learning approach. So, the depth can be estimated by a, for example, trained deep learning approach. The training data can be easily generated from real images of water-filed potholes and a (manually or automatically) measured depth of the corresponding water-filled potholes. Using this approach, potholes of various shapes and depths etc. can be easily determined.

In a further embodiment the processor is configured to estimate the depth of the at least one at least partially water-filled pothole by comparing the surface temperature of the water-filled potholes with a temperature of the surrounding surface area, and/or by comparing the surface temperature of the water-filled potholes with each other. By this, an fast estimation can be achieved.

In a further aspect of the present invention the system further comprises at least one radar sensor camera, which is configured to measure the reflected beam of the road surface, the processor further configured to estimate the depth of the at least one at least partially water-filled pothole by the reflected beam and the surface temperature of the at least one at least partially water-filled pothole.

By this a good determination of the depth can be achieved even with, for example, half water-filled potholes.

Furthermore, in one embodiment, the system can be coupled to an extern weather station. In case of rain or snow or bad weather in general the system can automatically activate itself. In case of a long heat period and for example driving along a highway the system can automatically deactivate itself and use the common radar sensor for detecting the pothole (not filled with any water due to the long heat period).

The object is further achieved by a driver assistance system (ADAS) comprising a system for estimating the depth of the at least one at least partially water-filled pothole according to one of the preceding claims, the driver assistance system being configured to output an alert in the event of a predefined number of at least partially water-filled potholes detected by the system and/or a predefined depth of at least one at least water-filled pothole detected by the system. In addition, a detected deep pothole can be shown/marked on a driver display. This enables the driver to choose his route, for example, in such a way that particularly the deep potholes can be avoided. Therefore, a smooth journey is possible and damages can be avoided.

In case of an autonomous or semi-autonomous operating driver assistance system, the driver assistance system is preferably further configured, in the event of a predefined number of at least partially water-filled potholes and/or a predefined depth of at least one at least partially water-filled pothole detected by the system, to select operation parameters for determining a trajectory, by which an avoidance or reduction of an at least partially water-filled pothole and/or an avoidance of the at least one deep at least partially water-filled pothole is achieved.

Therefore, a smooth journey can be achieved and damages can be avoided automatically.

In one embodiment the operation parameters comprise at least the parameter for controlling the steering, to avoid accidents. The ADAS will then give a control signal with the steering parameters to a steering system and/or an ABS system.

In a further aspect of the present invention the operation parameters comprise at least the parameter for controlling the suspension system.

Furthermore, in one embodiment the driver assistance system is configured to select the parameter for controlling the suspension system in such way that a smooth journey for the passenger is possible.

The object is further achieved by a method for estimating the depth of at least one at least partially water-filled pothole by a driver assistance system provided in a vehicle, the method comprising:
detecting at least one at least partially water-filled pothole based on camera data generated by at least one optical camera sensor,
determining a road surface temperature, the surface comprising the surface of the at least one at least partially water-filled pothole, whereby the determination of the road surface temperature is based on the temperature determination of the pixels in a thermal pixel image generated by the at least one thermal camera sensor,
determining the surface temperature of the at least one at least partially water-filled pothole detected by the at least one optical camera sensor based on the road surface temperature detected by the at least one thermal camera sensor,
estimating the depth of the at least one at least partially water-filled pothole by its surface temperature.

The advantages of the system can also be rolled out to the method. The method can be carried out in particular using a system according to the invention in one or more of the described embodiments.

In one embodiment the temperature of the surface is determined from a measured emission spectrum by using Planck's law of black body radiation.

In a further aspect of the present invention a trained machine learning approach for estimating the depth of the at least one at least partially water-filled pothole is used.

Further details and aspects of the invention will become apparent from the following description of preferred embodiments, in particular in conjunction with the dependent claims. In this case, the respective features can be implemented on their own or in combination with one another. The invention is not limited to the embodiments. The embodiments are shown schematically in the figures, wherein:

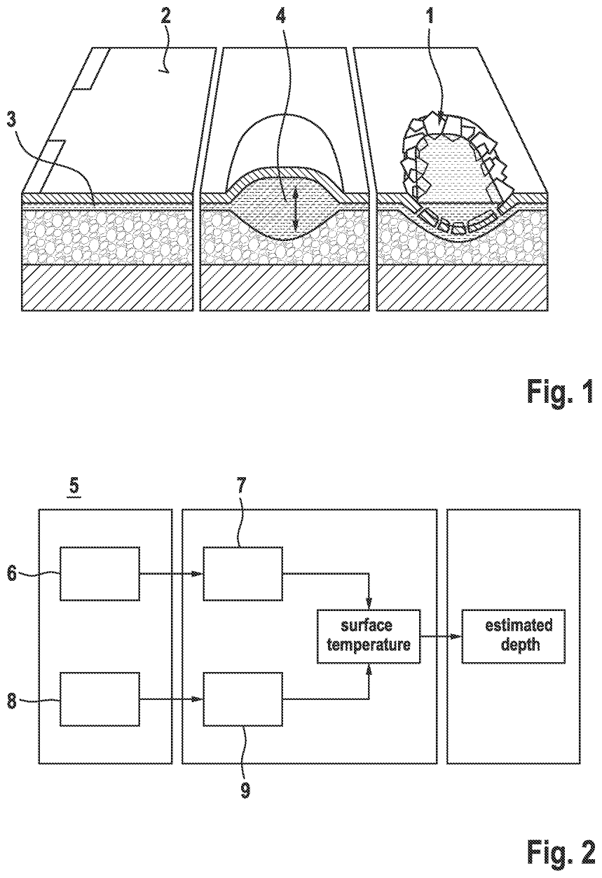

FIG. 1 schematically shows the formation of a pothole,

FIG. 2 schematically shows the system of the invention,

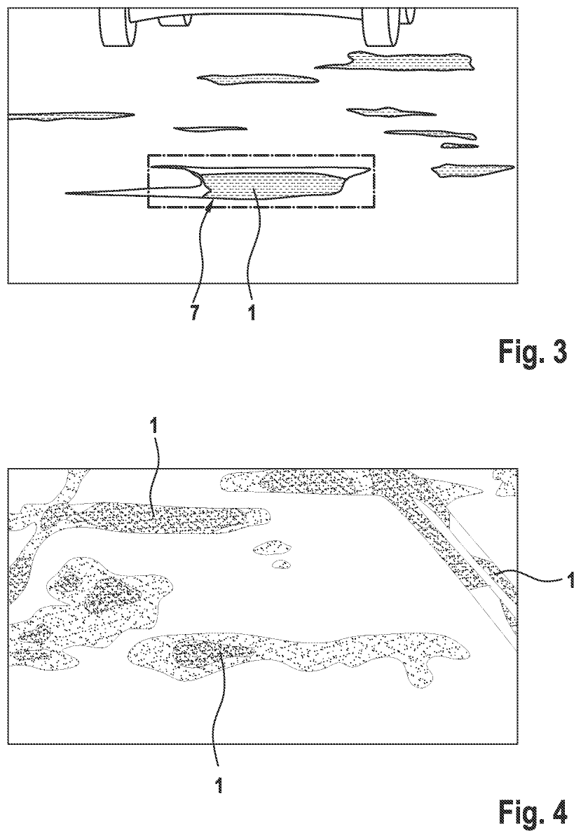

FIG. 3 shows schematically a pothole segmentation in the image,

FIG. 4 shows schematically potholes segmented using a CNN,

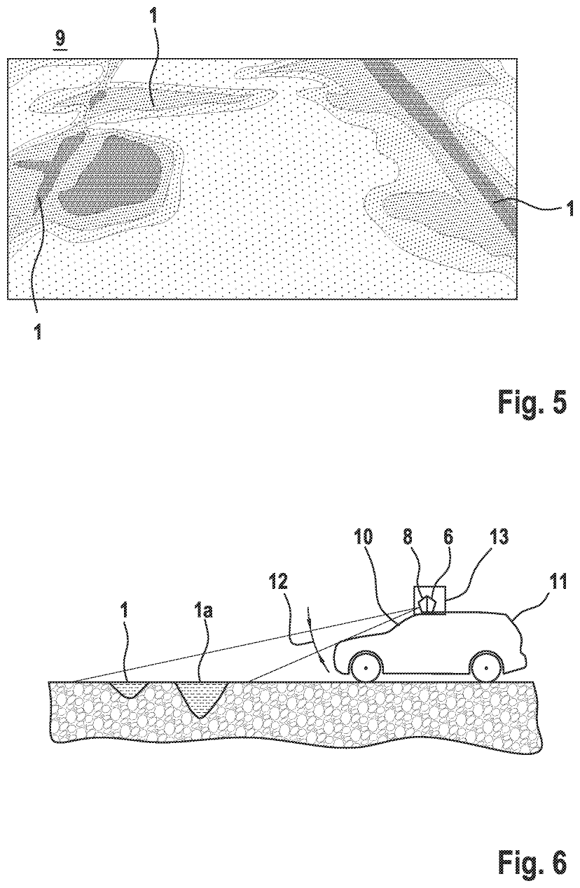

FIG. 5 shows schematically a thermal pixel image,

FIG. 6 shows a vehicle with a driver assistance system,

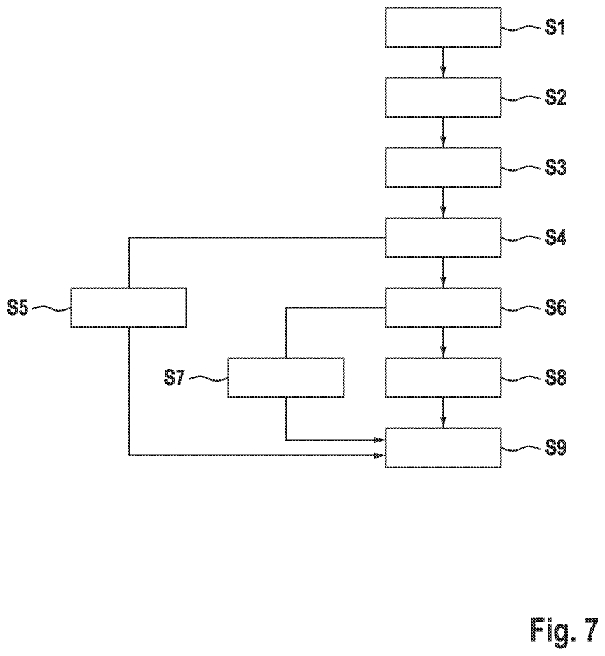

FIG. 7 shows schematically the method.

FIG. 1 schematically shows the formation of water-filled potholes 1.

Potholes 1 are caused by the expansion and contraction of water 3 that seeps into the ground under the asphalt and pavement/road surface 2.

Potholes 1 are further caused, when pavement/road surface 2 comes under severe stress from severe weather for example ice 4 and the constant pressure of oncoming traffic.

FIG. 2 schematically shows the system 5 for estimating the depth of a water-filled pothole 1 of the invention.

The systems 5 comprises a RGB (Red-Green-Blue)-camera sensor 6. The RGB-camera sensor 6 generates camera data of the road surface/pavement surface 2. The RGB-camera sensor 6 is usually equipped with a standard CMOS sensor through which coloured images are acquired. The acquisition of static images is usually expressed in megapixels.

The RGB (Red-Green-Blue)-camera sensor 6 itself or a processor is used to segment the areas of the water-filled potholes 1 from the rest of the image. Therefore, the RGB (Red-Green-Blue)-camera sensor 6 comprises or uses preferably a Convolution Neural Network for fast and accurate real time segmentation. Convolutional Neural networks (CNN) are most commonly applied to analyse visual images. CNNs are used for image classification and recognition because of its high and fast accuracy.

FIG. 3 shows schematically a water-filled pothole 1 segmentation 7 in the image (image data) generated by the RGB (Red-Green-Blue)-camera sensor 6.

FIG. 4 shows schematically water-filled potholes 1 segmented with CNN in the megapixels image created by the RGB (Red-Green-Blue)-camera sensor 6. Potholes 1 are also for example cracks in the pavement/road surface 2.

In addition, the system 5 comprises of a thermal camera sensor 8, which generates a thermal pixel image 9 (FIG. 4) of the pavement/road surface 2. The thermal camera sensor 8 is for example a high-speed infrared imaging camera.

The thermal camera sensor 8 determines a road surface temperature of the road/pavement surface 2 including the detected water-filled potholes 1. This determination is based on the temperature determination of each pixel in a thermal pixel image 9 (FIG. 5).

FIG. 5 shows schematically a thermal pixel image 9 with water-filled potholes 1 segmented with CNN.

Therefore, by fusion of the information about the water-filled potholes 1 detected by the RGB (Red-Green-Blue)-camera sensor 6 and information about the road surface temperature determined by the thermal camera sensor 8, the temperature of the pothole's surface 1 can be calculated.

This estimate based on the assumption that the surface temperature of a deep water-filled pothole 1 will be less than the surface temperature of a narrow water-filled pothole 1.

Therefore, the system 5 comprises a processor (for example integrated in the sensors 6, 8 or a standalone processor).

To determine the surface temperature, for example the Planck's law (black body emission concept) may be used, which will precisely tell the accumulated temperature at the pothole surface and therefore give a good estimation for depth too.

The integration of Planck's law over all frequencies provides the total energy per unit of time per unit of surface area radiated by a black body maintained at a temperature T. This is known as the Stefan-Boltzmann law:

$$\frac{P}{A} = σ {T}^{4}$$

where σ is the Stefan-Boltzmann constant and P is the power over the given surface area A.

Once the temperature has been determined for the pixels in the thermal pixel image 9, it is possible to determine the depth of the water-filled potholes 1 in any environment (like fog, rain, at night). Especially in fog, where the front scene is usually not even visible or in other extreme weather conditions, a depth estimation for water-filled potholes 1 can be given.

The processor is configured to estimate the depth of the water-filled pothole 1 by its surface temperature. Therefore, the processor uses a trained deep learning approach. That increases the overall accuracy of estimating the water-filled pothole's 1 depth.

The training data for this can easily be generated from real images of water-filled potholes 1 and their (manually or automatically) measured depth. With this approach, potholes of various shapes and depths etc. can easily be determined.

Preferably the RGB-camera sensor 6 and thermal camera sensor 8 are arranged on the top of a windshield 10 of a vehicle 11 (FIG. 6) forming a field of view 12 (FIG. 6).

FIG. 6 shows a vehicle 11 with a driver assistance system (ADAS, 13) comprising a system 5 for estimating the depth of a first water-filled pothole 1 and a second water-filed water-filled pothole 1a.

The system 5 comprises the RGB (Red-Green-Blue)-camera sensor 6 and thermal camera sensor 8 arranged on the top of the windshield 10 of the vehicle 11 (FIG. 6) forming the field of view 12.

The system 5 detects the water-filled potholes 1, 1a and estimates the depth. Here the depth of water-filled pothole 1a is larger than the depth of water-filled pothole 1.

That means, the surface temperature for the water-filled pothole 1a will be less compared to narrow water-filled pothole 1, because hot bodies emit more radiation than cold bodies/objects. As deep water-filled pothole 1a have more water than a narrow water-filled pothole 1, the accumulated temperature of the deep water-filled pothole 1a will be less compared pothole 1.

The driver assistance system 13 is further configured to output an alert in the event of a predefined depth (here for example the deep water-filled pothole 1a).

Further the deep water-filled pothole 1a can be shown on a display for example. This allows the driver to choose his/her route, for example, in such a way that particularly the deep pothole 1a can be avoided. Therefore, a smooth journey is possible and damages can be avoided.

In case the driver assistance system 13 is configured for autonomous or semi-autonomous operation, the driver assistance system 13 selects in the event of a predefined number of detected water-filled potholes 1 and/or a predefined depth of at least one pothole 1a, operation parameters for determining a trajectory by which an avoidance or reduction of the detected water-filled potholes 1 and/or avoidance of the detected deep water-filled pothole 1a is possible.

Preferably the operation parameters comprise at least the parameter for controlling the steering to avoid accidents or damages.

Preferably the operation parameters comprise at least the parameter for controlling the suspension system to give smooth journey for passengers and to avoid damages by deep water-filled pothole 1a.

Furthermore, by the use of a thermal camera sensor 8 a better view at night is possible as well as a better view in the fog.

FIG. 7 shows schematically one possibly embedment of the inventive method.

The method starts at a first step S1.

In a second step S2 the RGB (Red-Green-Blue)-camera sensor 6 detects all water-filled potholes 1, 1a and the thermal camera sensor 8 detects the road surface temperature.

In a third step S3 a fusion of the data of the RGB-camera 6 and the thermal camera data is done.

In a fourth step S4 the surface temperature of the water-filled potholes 1,1a and the temperature of the surface of the road pavement 2 is determined. This refers in particular to the surface of the road pavement 2, which are located in the surroundings of the water-filed potholes 1, 1a.

In a fourth step S4 the processor estimates the depth of the water-filled potholes 1, 1a by its surface temperature. For this purpose, the temperature of each water-filled porthole 1, 1a is compared with the temperature of the corresponding surrounding surface of the road surface 2.

If the surface temperature of the water-filled potholes 1, 1a is equal to or greater than the temperature of the surrounding surface area, very small, narrow potholes are present, fifth step S5.

If the surface temperature of the water-filled potholes is lower than the temperature of the surrounding surface area, the surface temperature of the water-filled pothole 1 is compared with the surface temperature of the water-filled pothole 1a, sixth step S6.

If the surface temperature of water-filled pothole 1 is lower than the surface temperature of pothole water-filled 1a, pothole 1 is deeper than pothole 1a, seventh step S7.

If the surface temperature of water-filled pothole 1a is lower than the surface temperature of water-filled pothole 1, pothole 1a is deeper than pothole 1, eighth step S8.

The results are forwarded to the ADAS in a step S9, which uses the results to calculate a new trajectory, for example.

### REFERENCE NUMBERS

1 water-filled pothole
1a deep water-filled pothole
2 pavement surface
3 water
4 ice
5 System
6 RGB (Red-Green-Blue)-camera sensor
7 pothole segmentation
8 thermal camera sensor
9 thermal pixel image
10 windshield
11 vehicle
12 field of view
13 driver assistance system

1. A system for estimating a depth of at least one at least partially water-filled pothole by a driver assistance system provided in a vehicle, the system comprising:
at least one optical camera sensor configured to detect the at least one at least partially water-filled pothole based on camera data generated by the optical camera sensor;
at least one thermal camera sensor configured to determine a road surface temperature, wherein the road surface comprises a surface of the at least one at least partially water-filled pothole, wherein the determination of the road surface temperature is based on temperature determination of pixels in a thermal pixel image generated by the at least one thermal camera sensor; and
a processor configured to;
determine a surface temperature of the at least one at least partially water-filled pothole detected by the at least one optical camera sensor, based on the road surface temperature detected by the at least one thermal camera sensor; and
estimate a depth of the at least one at least partially water-filled pothole based on the surface temperature of the at least one at least partially water-filled pothole.

2. The system of claim 1, wherein the at least one optical camera sensor and the at least one thermal camera sensor are arranged on a windshield of the vehicle.

3. The system of claim 2, wherein the at least one optical camera sensor and the at least one thermal camera sensor are arranged on a top of the windshield.

4. The system of claim 1, wherein the at least one optical camera sensor is a RGB (Red, Green, Blue) camera sensor.

5. The system of claim 1, wherein the processor is configured to determine the surface temperature of the at least one at least partially water-filled pothole from a measured emission spectrum.

6. The system of claim 1, wherein the processor is configured to estimate the depth of the at least one at least partially water-filled pothole using a trained machine learning method.

7. The system of claim 1, wherein the processor is configured to estimate the depth of the at least one at least partially water-filled pothole by comparing the surface temperature of the at least one at least partially water-filled pothole with a temperature of a surrounding surface area, and/or by comparing the surface temperature of the at least one at least partially water-filled pothole with another at least one at least partially water-filled pothole.

8. The system of claim 1, comprising:
at least one radar sensor camera configured to measure a reflected beam of the road surface,
wherein the processor is configured to:
estimate the depth of the at least one at least partially water-filled pothole using the reflected beam and the surface temperature of the at least one at least partially water-filled pothole.

9. A driver assistance system comprising:
the system of claim 1,
wherein the driver assistance system is configured to output an alert in an event of a predefined number of at least partially water-filled potholes detected by the system and/or a predefined depth of at least one at least partially water-filled pothole detected by the system.

10. The driver assistance system of claim 9, configured to:
operate in an autonomous or semi-autonomous operation mode;
in the event of a predefined number of at least partially water-filled potholes detected by the system and/or a predefined depth of at least one at least partially water-filled pothole detected by the system, select operation parameters for determining a trajectory, by which an avoidance or reduction of a number of at least partially water-filled potholes, and/or an avoidance of at least one deep at least partially water-filled pothole is achieved.

11. The driver assistance system of claim 10, wherein the operation parameters comprise at least a parameter for controlling steering.

12. The driver assistance system of claim 10, wherein the operation parameters comprise at least a parameter for controlling a suspension system.

13. A method for estimating a depth of at least one at least partially water-filled pothole by a driver assistance system provided in a vehicle, the method comprising:
detecting at least one at least partially water-filled pothole based on camera data generated by at least one optical camera sensor;
determining a road surface temperature comprising a surface of the at least one at least partially water-filled pothole based on temperature determination of pixels in a thermal pixel image generated by at least one thermal camera sensor;
determining the surface temperature of the at least one at least partially water-filled pothole detected by the at least one optical camera sensor based on the road surface temperature detected by the at least one thermal camera sensor; and
estimating a depth of the at least one at least partially water-filled pothole based on the surface temperature of the at least one partially water-filled pothole.

14. The method of claim 13, comprising:
determining the surface temperature of the at least one at least partially water-filled pothole using a measured emission spectrum.

15. The method of claim 13, comprising:
estimating the depth of the at least one at least partially water-filled pothole using a trained machine learning method.

16. The method of claim 13, comprising:
estimating the depth of the at least one at least partially water-filled pothole by comparing the surface temperature of the at least one at least partially water-filled pothole with a temperature of a surrounding surface area, and/or by comparing the surface temperature of the at least one at least partially water-filled pothole with another at least one at least partially water-filled pothole.

17. The method of claim 13, comprising:
measuring a reflected beam of the road surface by at least one radar sensor camera; and
estimating the depth of the at least one at least partially water-filled pothole using the reflected beam and the surface temperature of the at least one at least partially water-filled pothole.

18. The method of claim 13, comprising:
outputting an alert in response to detecting a predefined number of at least partially water-filled potholes and/or estimating a predefined depth of the at least one at least partially water-filled pothole.

19. The method of claim 18, comprising:
operating the vehicle in an autonomous or semi-autonomous operation mode; and
in response to detecting a predefined number of at least partially water-filled potholes and/or estimating a predefined depth of the at least one at least partially water-filled pothole, selecting operation parameters for determining a trajectory, by which an avoidance or reduction of a number of at least partially water-filled potholes, and/or an avoidance of at least one deep at least partially water-filled pothole is achieved.

20. The method of claim 19, comprising:
controlling at least one of steering or a suspension system of the vehicle using the operation parameters.
